(19) United States
(12) Patent Application Publication
(10) Pub. No.: US 2013/0113603 A1
(43) Pub. Date: May 9, 2013

(54) ACCESS CONTROL SYSTEM FOR A GATE OR A DOOR

(71) Applicant: Gerd Schaaf, Kirchheim/Teck (DE)

(72) Inventor: Gerd Schaaf, Kirchheim/Teck (DE)

(73) Assignee: SOMMER ANTRIEBS-UND FUNKTECHNIK GMBH, Kirchheim/Teck (DE)

(21) Appl. No.: 13/810,361

(22) PCT Filed: Jul. 8, 2011
(86) PCT No.: PCT/EP11/03425

§ 371 Date: Jan. 15, 2013

(30) Foreign Application Priority Data
Aug. 14, 2010 (DE) 20 2010 011 390.3

(51) Int. Cl. G05B 1/01

(52) U.S. Cl. CPC G05B 1/01
USPC 340/5.53

(57) ABSTRACT

A method to access a control system for a gate or a door, wherein the control system includes a fingerprint sensor, a scanner for capturing a fingerprint as a user identifier for a user, a sensor element for activating the scanner and a computer unit, which stores a number of user identifiers. A fingerprint captured using the scanner is compared, as a currently input user identifier, with the user identifiers which are stored in the computer unit. If there is a match between the currently input user identifier and a stored user identifier, the fingerprint sensor outputs a control signal to a control unit, as a result of which the latter operates the gate or the door. Signals generated in the scanner are used to selectively call individual memory locations in the computer unit in order to erase or store individual user identifiers therein.

### CROSS-REFERENCE TO RELATED APPLICATIONS

This application is a U.S. national stage of International Application No. PCT/EP2011/003425, filed Jul. 8, 2011, claiming priority from German application DE 20 2010 011 390.3 filed Aug. 14, 2010.

### BACKGROUND

The invention relates to an access control system for a gate or a door, with a fingerprint sensor that includes a scanner for capturing a fingerprint as an identifier for a user, a sensor element for activating the scanner, a computer unit in which a number of user identifiers are stored, wherein a fingerprint captured by the scanner as a currently input user identifier is compared to the user identifiers stored in the computer unit and, if a match is found between the currently input user identifier and a stored user identifier, a control signal is transmitted by the fingerprint sensor to a control unit, so that the control unit can operate the gate or the door.

Access control systems of this type have been used more and more in recent years because the biometric fingerprint sensors used offer high user comfort as well as high manipulation security. The fingerprint sensor of such an access control system reads the fingerprint of a user who wants to activate the door or gate. The control unit will enable the activation, meaning the opening or closing of the gate or the door, only if the fingerprint is recognized as valid in the fingerprint sensor, meaning if this fingerprint as the currently input user identifier matches a user identifier stored in the computer unit of the fingerprint sensor. A control segment, that is to say a signal for enabling the activation of the gate or the door, is generated in the computer unit of the fingerprint sensor only if a match is detected, whereupon this signal is transmitted to the control unit which then opens the gate or the door.

For most applications, it is desirable and makes sense to have several persons with access authorization, meaning they are authorized to activate the gate or the door. Several user identifiers are therefore typically stored in the computer unit, so that the fingerprints of the persons are recognized as being valid in the fingerprint sensor.

One difficulty, however, is encountered if the user identifiers which are stored in the computer unit must be changed. A particular disadvantage for known systems operating with fingerprint sensors is that all identifiers stored in the memory must be erased or erased completely and that a selective erasing of individually stored user identifiers is not possible or is possible only if the respective user is present whose fingerprint is stored as user identifier which is to be erased, so that this user can input the fingerprint into the fingerprint sensor for the erasing.

In principle, this functional restriction could be remedied by providing an additional programming unit with a separate display which, however, would result in undesirable additional structural expenditure.

### SUMMARY OF THE INVENTION

It is the object of the present invention to provide an access control system of the aforementioned type which offers high user friendliness along with low structural expenditure.

The above and other objects are accomplished according to the invention, which in one embodiment includes a method to access a control system for a gate or a door, wherein the control system comprises a fingerprint sensor, a scanner for capturing a fingerprint as user identifier, a sensor element for activating the scanner, and a computer unit in which a number of user identifiers are stored. A fingerprint captured with the scanner as currently input user identifier is compared to the user identifiers stored in the computer unit. If the currently input user identifier matches a stored user identifier, a control signal is sent by the fingerprint sensor to a control unit, so that it can activate the gate or the door. The method includes generating signals in the scanner, to selectively call up individual memory locations in the computer unit in order to erase or input individual user identifiers.

The invention is based on the premise of allowing a selective erasing and input of individual user identifiers in the computer unit by using the components of the fingerprint sensor. As a result, no separate programming unit and, in particular, no separate display unit is required for the erasing and input functions. As a result, these functions can be made available without any additional structural expenditure.

The access control system according to the invention has a high functionality since a user, by using the components of the fingerprint sensor, not only can input individual new user identifiers as desired into the computer unit of the access control system, but can also purposely erase individual user identifiers that are stored in the computer unit. As a result, it is no longer necessary to erase all user identifiers during an erasing operation, thereby dispensing with a time-consuming new input of the user identifiers.

The respective memory locations necessary for the individual input or erasing operations are called up with a suitable activation of the scanner. In addition to its basic function, the scanner thus meets an additional function. The selective erasing and input of individual user identifiers can thus be realized with little expenditure as a result of the multi-function capacity of the scanner.

The operation of the access control system according to the invention is divided into an operating mode and one or several teaching processes.

During the operating mode, the gate or the door is activated once the fingerprint sensor captures a valid user identifier, meaning a fingerprint that matches a user identifier stored in the computer unit.

In order to read a fingerprint, the respective finger is guided in a reading direction over the fingerprint sensor and is thus scanned by the scanner.

The selective erasing or input of the user identifiers, on the other hand, is realized with a teaching process. By placing a finger onto the sensor element during a first time interval, a teaching process for erasing a user identifier is advantageously started; by placing a finger onto the sensor element during a second time interval, a teaching process for the input of a user identifier is started; and by placing a finger onto the sensor element during a third time interval, a teaching process is started for erasing all user identifiers.

The sensor element thus meets an additional function in that a certain teaching process is started through specific activation of the sensor element. Incorrect operations and mix-ups can thus easily be avoided by providing different teaching processes for the erasing and the input of user identifiers.

In one embodiment the teaching process may be enabled by reading the fingerprint of an administrator with the fingerprint sensor.

As a result, the safety of the access control system is increased since a teaching process cannot be enabled by unauthorized persons, but only by the administrator as the authorized user. A precondition, of course, is that the fingerprint of the administrator must be known to the computer unit, meaning it is stored therein.

As soon as a teaching process is enabled by the administrator, the user identifiers are stored in a computer unit memory at locations designated with numbers, wherein the memory locations can be selectively called up by activating the scanner during the teaching process.

The scanner captures two different directions for this in which a finger can be guided past the sensor element and, depending on the direction-dependent signals generated as a result, an incrementing or decrementing of the called up memory location takes place.

The number for the called up memory location is advantageously displayed for the respective user by a display element that is integrated into the fingerprint sensor, wherein this increases the user comfort and also prevents incorrect uses. In one embodiment the display element may be visible only during the teaching process, but not during the operating mode or during a standby operation, thus providing an appealing design.

A user identifier may be input at a called up memory location in that the fingerprint of a user is read by the fingerprint sensor. In the process, the fingerprint may be stored at the selected memory location as the new user identifier.

The fingerprint of the administrator may be read during a teaching process in order to erase a user identifier from a called up location, or to erase all user identifiers, wherein the erasing operation is carried out only once the fingerprint of the administrator is captured.

To input a new user identifier, the fingerprint of the user is read which is to be stored as the new user identifier. In contrast, a user identifier is always erased by reading the fingerprint of the administrator. Since consequently only the administrator can erase a user identifier, it is not possible for unauthorized persons to erase user identifiers, wherein it is an advantage that the person whose fingerprint as a user identifier is to be erased does not have to be present.

The erasing and the input of user identifiers are realized solely in the fingerprint sensor. Thus, a check to determine whether or not a valid user identifier was entered during the operating mode may be also realized only in the fingerprint sensor. Accordingly, the control signal generated in the fingerprint sensor may be an output signal, which functions to activate the gate or the door directly, without additional check.

The control signal in this case is a coded signal, thereby ensuring a manipulation-safe transmittal of the control signal to the control unit.

With the access control system according to the invention, the input of a fingerprint into the fingerprint sensor and the subsequent generating of the control signal generally represent only one option for activating the gate or the door which is used parallel to additional activation means.

For example, additional radio transmitters in the form of hand-held transmitters can be used for opening and closing a garage door.

### BRIEF DESCRIPTION OF THE DRAWINGS

In the following, the invention is explained with the aid of the drawings, which show in:

FIG. 1A schematic representation of an access control system for a gate;

FIG. 2 A view from above of a fingerprint sensor for the access control system according to FIG. 1, in an operating mode;

FIG. 3 A view from above of the fingerprint sensor according to FIG. 1 during a teaching process.

### DETAILED DESCRIPTION

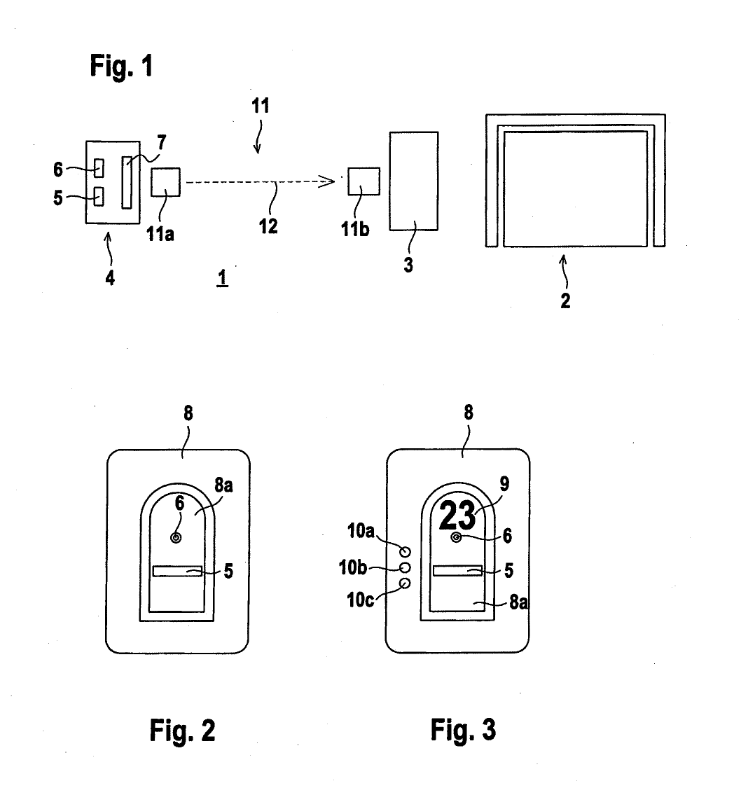

FIG. 1 shows a schematic representation of the basic configuration of an access control system 1 for a garage door 2. The access control system 1 can generally also be used for different gates and also for doors. In a manner known per se, the garage door 2 is controlled by a control unit 3 and can thus be activated, meaning it can be opened or closed. For this operation, the control unit 3 is connected to a door drive, not shown herein, by means of which the garage door 2 can be opened or closed.

A biometric fingerprint sensor 4 is provided for the access control, so that the garage door 2 cannot be activated by just anyone but only by selected persons.

In a manner known per se, the fingerprint sensor 4 comprises a scanner 5 which can be used to read the fingerprints of persons. The fingerprint sensor 4 furthermore comprises a sensor element 6 which can be used to activate the scanner 5 for reading a fingerprint. For the present case, the sensor element 6 is a capacitive sensor. Alternatively, the sensor element 6 can also be embodied as an inductive sensor, mechanical sensor, and the like.

The scanner 5 and the sensor element 6 are connected to a computer unit 7 in the form of a micro-controller. A memory is integrated into the computer unit 7.

The fingerprint sensor 4 is integrated into a housing, wherein FIGS. 2 and 3 provide a view from above of a cover 8 that forms the front wall of the housing and is composed of translucent plastic. As a result of the cover 8, all operating and display elements 9 are protected against the environment, with the exception of the scanner 5, so that only a single seal is required for the complete fingerprint sensor. This cover 8 has a flat edge region and an indentation 8a in the center which is adapted to the shape of a fingertip. In the region of this indentation 8a, the sensor elements 6 and the scanner 5 are located directly behind the indentation 8a, with the sensor element 6 being located above the scanner 5.

The fingerprint sensor 4 furthermore contains a display mechanism which is activated by the computer unit 7 and is located directly behind the cover 8. The display mechanism 9 in the form of an illuminated alpha-numerical display may be provided as a first display mechanism. Additional display mechanisms are three discrete light-emitting diodes 10a, b, c which preferably light up with different colors.

The computer unit 7 controls the display mechanisms so that these display mechanisms are only activated and visible during a teach-in process (as shown in FIG. 3), but not during a teach-in process (as shown in FIG. 2).

The fingerprint sensor 4 can theoretically be connected to the control unit 3 via a cable connection, wherein this may be advantageous if the fingerprint sensor 4 is to be installed in a wall.

In the present case, the fingerprint sensor 4 may be connected to the control unit 3 via a radio path 11 which comprises a radio transmitter 11a that is connected to the fingerprint sensor 4 and a radio receiver 11b which is connected to the control unit 3; The radio transmitter 11a may transmit radio signals 12 to the radio receiver 11b. As a result, an output signal generated by the fingerprint sensor 4 can be transmitted to the control unit 3. The system emitting radio signals generally can be expanded such that a radio transmitter 11a and a radio receiver 11b is respectively assigned to the fingerprint sensor 4 and the control unit 3, thus making possible a bi-directional transmission of radio signals 12.

In that case, the fingerprint sensor 4 is surface-mounted together with the radio transmitter 11a on an outside wall of the garage and forms an outside unit. The control unit 3 is arranged inside the garage and forms an inside unit.

During the operating mode, the fingerprint sensor 4 is used to operate the garage door 2, meaning to open and close it. The door is operated by authorized users for which the fingerprints are stored as user identifiers in the memory of the computer unit 7. The user identifiers are stored at specified memory locations which are characterized by numbers.

A user wanting to operate the garage door 2 places one finger into the indentation 8a in the cover 8 and moves the finger from the top to the bottom, thus activating the scanner 5 which can read the fingerprint. The fingerprint which is read in this way as a currently input user identifier is then compared to the user identifiers stored in the computer unit 7. If the current input user identifier does not match any of the stored user identifiers, this is categorized in the computer unit 7 as an invalid access attempt, so that the computer unit does not transmit an output signal to the control unit 3 for activating the garage door 2. On the other hand, if the current input user identifier matches one of the stored user identifiers, this is categorized as valid access attempt by the computer unit 7. In that case, a control signal is generated in the computer unit 7 and is read into the control unit 3, thereby activating the garage door 2. The control signal theoretically could be a binary switching signal. To ensure sufficient protection against manipulation, the fingerprint sensor 4 transmits a coded control signal which is then decoded in the control unit 3.

During the time period in which the garage door 2 is operational, it may be desirable to change the user identifiers stored in the computer unit 7 from time to time in order to change the group of people with access authorization to the garage.

A change in the configuration of this type is realized with a teaching process for selectively erasing or inputting the user identifiers.

In the present case, respectively one separate teaching process is provided for the erasing or the input of the user identifier or for erasing all user identifiers.

A teaching process is initiated in that the user places a finger for a specified time interval into the indentation 8a and thus holds it on the sensor element 6. Since the finger rests immovably on the sensor element 6, the signal generated in this way differs from the signal of the sensor element 6 for activating the scanner 5.

If the finger remains for 5 seconds on the sensor element 6, as in the present case, the teaching process for the input of a new user identifier is started. If the finger remains for 10 seconds on the sensor element 6, a teaching process for erasing a user identifier is started. If the finger remains for 20 seconds on the sensor element 6, a teaching process for erasing all user identifiers is started.

However, the respective teaching process is enabled only if immediately thereafter the fingerprint of an administrator is also read, wherein the fingerprint of the administrator is stored separately in the memory of the computer unit 7. For the reading of the fingerprint, the administrator moves the finger through the indentation 8a in the cover 8 of the housing for the fingerprint sensor 4. If the fingerprint of the administrator is recognized by the fingerprint sensor 4, the teaching process is enabled.

During the respectively ongoing teaching process the display mechanism is activated, meaning the display element 9 and the light-emitting diodes 10a, b, c are visible behind the cover 8. The status of the enabled teaching process is indicated, for example, by a continuously lit diode 10a (e.g. a red one). With both teaching processes, the respective storage location for the input or erasing of a user identifier is called up by activating the sensor element 6. In the process, a user who does not need to be the administrator moves the finger sideways over the scanner 5, meaning transverse to the up and down reading direction. This manner of activating the scanner 5 can be distinguished clearly in the computer unit 7 from the process of reading a fingerprint. The computer unit 7 can furthermore distinguish whether the finger is moved from the left to the right or from the right to the left over the scanner 5. Depending on the movement direction, an incrementing or decrementing by the value of 1 takes place in the currently selected storage location. If an incrementing or decrementing of the storage location by a greater value is desired, the finger is guided several times successively sideways in the respective movement direction over the scanner 5. The number for the currently selected storage location is indicated on the display element 9. For the case shown in FIG. 3, the storage location No. 23 is indicated. The user thus has control over when the desired storage location is selected.

If a new user identifier is to be input and the corresponding teaching process has been enabled, the user moves his/her finger through the indentation 8a in the cover 8 following the selection of the desired storage location, so that his/her fingerprint is read. The fingerprint read in this way is then input as the new user identifier at the selected storage location, wherein this is indicated to the user via an individual activation of the light-emitting diodes 10a, b and c.

For the input of a user identifier, only the teaching process part is realized by the administrator. The remaining part of the operation is realized by the user whose fingerprint is to be entered as a user identifier. In contrast, the erasing of user identifiers is always realized by the administrator as the authorized person, wherein generally several administrators can also be authorized by specifying their fingerprints.

If only one user identifier is to be erased and the corresponding teaching process has been enabled, the administrator selects the storage location for the user identifier to be erased. The administrator then moves his/her finger over the fingerprint sensor 4, so that the fingerprint is read. If this fingerprint is identified in the computer unit 7, the erasing process is carried out and is indicated through the individual activation of the light-emitting diodes 10a, b and c.

If all user identifiers are to be erased and the respective teaching process for this is enabled, the administrator moves his/her finger over the fingerprint sensor 4 so that the fingerprint is read. If the fingerprint is identified in the computer unit 7, the erasing operation is carried out and is indicated through the individual activation of the light-emitting diodes 10a, b and c.

1. A method to access a control system for a gate or a door, wherein the control system includes a fingerprint sensor comprising a scanner to capture a fingerprint as an identifier for a user, a sensor element to activate the scanner; and a computer unit in which a number of user identifiers are stored, the method comprising;
comparing a fingerprint captured by the scanner as a currently input user identifier to the user identifiers stored in the computer unit and, if a match is found between the currently input user identifier and a stored user identifier, transmitting a control signal by the fingerprint sensor to a control unit for the control unit to operate the gate or the door; and
selectively generating signals in the scanner to call up individual memory locations in the computer unit to erase or input separate user identifiers.

2. The method according to claim 1, further comprising using one of a capacitive or an inductive sensor, a reed switch, or a mechanical switch as the sensor element.

3. The method according to claim 1, further comprising reading a fingerprint by scanning with the scanner, the respective finger while the finger is moved in a reading direction across the fingerprint sensor.

4. The method according to claim 1, further comprising starting a teaching process for erasing a user identifier by placing a finger onto the sensor element during a first time interval, starting a teaching process for an input of a user identifier by placing a finger onto the sensor element during a second time interval, and starting a teaching process for erasing all user identifiers, placing a finger onto the sensor element during a third time interval.

5. The method according to claim 4, further including enabling the teaching process as a function of a reading of a fingerprint of an administrator by the fingerprint sensor.

6. The method according to claim 4, including storing the user identifiers at different locations, characterized by numbers, in a memory for the computer unit, wherein the memory locations are called up selectively within a teaching process by activating the scanner.

7. The method according to claim 6, further comprising capturing, with the aid of the scanner, two different directions in which a finger is moved past the scanner and incrementing or decrementing the selected memory location, depending on direction-dependent signals generated by the scanner.

8. The method according to claim 6, further comprising reading a fingerprint of a user with the fingerprint sensor, and storing the read fingerprint at the selected memory location as a new user identifier.

9. The method according to claim 5, wherein during the teaching process for erasing a user identifier at a selected memory location or during the teaching process for erasing all user identifiers, reading the fingerprint of the administrator and performing the respective erasing only if the fingerprint of the administrator is identified.

10. The method according to claim 6, wherein the sensor includes a display element, and the method further includes functioning the fingerprint sensor to indicate a number for the called up memory location on the display element.

11. The method according to claim 1, wherein the fingerprint sensor comprises a cover with an indentation that corresponds to a shape of a fingertip, and further comprising arranging sensor element and the scanner in a region of the indentation.

12. The method according to claim 11, further including composing the cover of translucent plastic, with an arrangement of light-emitting diodes and positioning the display element positioned below the cover.

13. The method according to claim 1, including transmitting the control signal the fingerprint sensor to the control unit via a cable connection or via a radio path.

14. The method according to claim 1, wherein the control signal is a coded signal.
